(19) United States
(12) Patent Application Publication
(10) Pub. No.: US 2007/0264381 A1
(43) Pub. Date: Nov. 15, 2007

(54) Method and mold for molding flexible polymeric envelopes

(76) Inventor: Stephen T. Garelli, Templeton, CA (US)

Correspondence Address: MCKELLAR IP LAW, PLLC, 784 SOUTH POSEYVILLE ROAD, MIDLAND, MI, 48640, US

(21) Appl. No.: 11/879,125

(22) Filed: Jul. 16, 2007

Related U.S. Application Data
(62) Division of application No. 10/051,200, filed on Jan. 17, 2002, now abandoned.

(51) Int. Cl. B29C 45/40

(52) U.S. Cl. 425/437

(57) ABSTRACT

Method of molding flexible polymeric envelopes, the mold useful therefor, and the products that are produced by such a method. The essence of this process is the ability to injection mold the polymeric envelopes, cure or dry them on the mold core, and in spite of the small opening left by the molding process as compared to the size of the large core, eject the molded product without splitting or tearing the product in the process of demolding using gas injection to expand the molded product.

This application claims priority from U.S. Utility Ser. No. 10/051,200 filed Jan. 17, 2002.

The invention disclosed and claimed herein deals with a method of molding flexible polymeric envelopes, the mold useful therefor, and the products that are produced by such a method.

The essence of this invention is the ability to injection mold the polymeric envelopes, cure or dry them on the mold core, and in spite of the small opening left by the molding process as compared to the large core, eject the molded product without splitting or tearing the product in the process of demolding.

The process not only facilitates the demolding process, but also produces products with consistent and repeatable predetermined wall thicknesses. The process also allows for the product to have a variety of textures on its inside or outside surfaces, or both surfaces. Further, the process of this invention allows for reinforcement of the product in those areas that are susceptible to damage or breakage, or the like.

Thus, there is a consistency of result, economical advantages because the product can be injection molded, a reliable manufacturing process that does not require huge capital investment for the high quantities of product that can be produced, and, the cost of the product is low because of the efficient manufacturing methods.

### BACKGROUND OF THE INVENTION

The inventor herein is aware of two publications that deal with the manufacture of polymeric flexible envelopes. These envelopes are manufactured as products useful in human breast implantation. For example, U.S. Pat. No. 5,437,824, that issued to Carlisle, et al., on Aug. 1, 1995, deals with a method of forming a molded silicone foam implant having open-celled interstices wherein the product is molded using a cast molding technique and U.S. Pat. No. 5,965,076, that issued on Oct. 12, 1999 to Banks, et al., deals with a method for fabricating soft tissue implants with microscopic surface roughness, in which the product is manufactured by a vacuum molding process.

The inventor is not aware of any publications that deal with polymeric flexible envelopes in which the envelopes are manufactured by injection molding and the products are demolded by injecting them with gas.

### THE INVENTION

This invention deals with a method of molding flexible polymeric envelopes, the mold useful therefor, and the products that are produced by such a method.

Thus, more specifically, this invention deals in one embodiment with a mold wherein the mold comprises an upper mold segment having an upper surface, a lower mold segment having a bottom surface, and, a moveable core having a top surface, a bottom surface and a centered opening therethrough. The centered opening has a near end and a distal end

Each mold segment has a confronting flat surface and the mold segments are capable of mating with each other at these respective confronting flat surfaces. There is located in the confronting flat surface of each segment, a concavity and each concavity has an opening centered in it.

The opening in the concavity of the lower mold segment runs through the lower mold segment and exits through the bottom surface of the lower mold segment thereby forming a channel through the lower mold segment.

The opening in the concavity of the upper mold segment runs through the upper mold segment and exits through the upper surface of the upper mold segment thereby creating a channel through the upper mold segment.

The moveable core has an outside configuration essentially reciprocal of the concavities when the mold segments are mated with each other (closed), the core having integrally attached to its bottom, a stem. The stem is slidably mounted in the opening in the concavity of the lower mold segment and extends beyond the bottom surface of the lower mold segment. The stem has a centered opening through it.

The centered opening in the core has an air valve located in and near the near end and the centered opening in the core and the centered opening in the stem are interconnected to allow the intermittent passage of gas through the core. There is a space created between the outside configuration of the core and the concavities when the mold segments are mated.

Another embodiment of this invention is a method of molding wherein the method comprises providing a molding machine containing a mold as defined Supra, providing a clamping force on the mold, injecting liquid moldable material into the upper mold segment via the upper mold segment opening and allowing the liquid moldable material to fill the space created between the outside configuration of the core and the concavities. Thereafter, allowing the liquid moldable material to become a solid molded product, removing the clamping force on the mold and separating the upper mold segment and the lower mold segment and thereafter, sliding the core towards the upper mold segment or lowering the lower mold segment such that the stem does not stay nested in the concavity of the lower mold segment. Finally, injecting gas into the centered opening in the stem, thereby opening the gas valve in the near end of the centered opening in the core, and allowing the solid molded product to be inflated by the injected gas until the solid molded product is released from the core and thereafter, removing the solid molded product from the mold.

There is yet another embodiment of this invention which is the products that are obtained by using the process set forth Supra, especially where the products are manufactured from curable silicone polymeric materials.

### BRIEF DESCRIPTION OF THE DRAWINGS

FIG. 1 is a full front view of a mold of this invention showing the core and molded product in phantom.

FIG. 2 is a cross-section full front view of the mold of FIG. 1, through line 100-100.

FIG. 3 is a partial segment of the core of the mold.

FIG. 4 is a partial segment of the core of the mold.

FIG. 5 is a partial segment of the core of the mold.

FIG. 6 is a partial segment of the core of the mold.

FIG. 7 is a partial segment of the core of the mold.

FIG. 8 is a partial segment of the core of the mold.

FIG. 9 is full front view of the mold of this invention in an opened position showing the core with an inflated product of this invention surrounding the core.

### DETAILED DESCRIPTION OF THE INVENTION

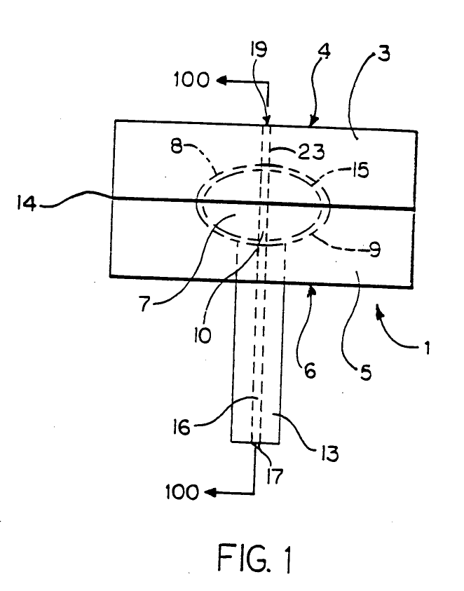

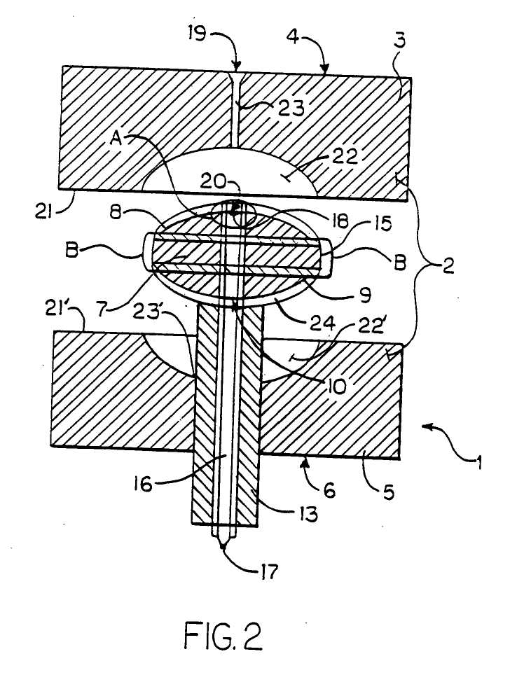

Turning now to the Figures, and with reference to FIG. 1, which is a full front view of a mold 1 of this invention. The mold 1 comprises a mold base 2 comprised of an upper mold segment 3, having an upper surface 4, a lower mold segment 5 having a bottom surface 6, and a moveable core 7 having a top surface 8, a bottom surface 9, and a centered opening 10, (shown in phantom) and in FIG. 2, wherein the centered opening 10 has a near end 11 and a distal end 12. There is also shown a stem 13. In addition, there is shown a mold parting line 14, all of which will be discussed Infra.

Taking into consideration both FIG. 1, and FIG. 2 which is a full cross-sectional front view of the mold 1 of FIG. 1 through line 100-100, wherein like numerals indicate like components, there is shown in addition, the molded product 15, the centered opening 16 in the stem 13, a connection 17, for injected gas, a gas valve 18, injection gate 19 for liquid molding material, opening 20 in the top surface 8 of the core 7, all of which will be discussed Infra.

Further, there is shown confronting flat surfaces 21 and 21′ for the upper mold segment 3 and the lower mold segment 5, respectively, concavity 22 for the upper mold segment 3 and the concavity 22′ for the lower mold segment 5.

Each of the concavities have an opening 23 for the upper mold segment 3, and 23′ for the lower mold segment 5, and the respective openings 23 and 23′ run through the upper mold segment 3 and the lower mold segment 23′, respectively. The opening 23′ exits through the bottom surface 6 of the lower mold segment 5. The opening 23 in the upper mold segment 3 runs through the upper mold segment 3 and exits through the upper surface 4 of the upper mold segment 3.

It should be understood that even though the Figures herein illustrate the concavities as being hemispherical concavities, it is contemplated within the scope of this invention that such concavities can have various configurations, especially where the product 15 is intended to be used for human breast implants wherein the configurations of the human breast are not necessarily symmetrical.

Again with reference to FIGS. 1 and 2, it should be noted that the confronting flat surfaces 21 and 21′ are constructed such that they contact and mate when the mold 1 is tightly closed during the molding process. It should be further noted that the stem 13 is slidable in the opening 23′, the reasons therefore being discussed Infra with regard to the molding process.

The outside configuration of the core 7 is such that it is essentially the counterpart to the configuration of the concavities 22 and 22′, such that when the mold 1 is closed, there is a small space 24 (FIG. 2) created to accept the liquid molding material when injected into the mold 1 through the gate 19.

Having described the various components of the mold 1, the molding process will now be described, and thus, the method comprises providing a molding machine for the mold, wherein any conventional injection molding machine can be utilized. It should be noted that the stem 13 is inserted into the opening 23′ in the lower molding segment 5 and seated therein. The mold 1 is then inserted into the injection molding machine and the mold 1 is clamped together such that the confronting surfaces 21 and 21′ are mated and tightly held. There is a mold parting line 14 created thereby.

The valve 18 is maintained in the closed position at this time. A predetermined amount of a liquid molding material is then injection molded through the gate 19 and allowed to flow around the core 7 and then the liquid molding material is allowed to cure, or dry, and then the mold 1 is unclamped and the mold segments 3 and 5 are separated. Curing may take place at room temperature, or any reasonable elevated temperature. The core 7 is then moved upwardly towards the upper mold segment 3 or the lower mold segment 5 is lowered away from the upper mold segment 3 such that the core 7 is essentially above the lower mold segment 5 and below the upper mold segment 3 to allow for expansion of the product 15 as will be described infra.

Gas, such as air, carbon dioxide, nitrogen, or some convenient gas is injected through the connection 17, through the opening 16, into the opening 10, wherein the valve 18 is activated to allow the gas to expand the product 15 in a balloon-like configuration.

It will be understood by those skilled in the art that the molding process provides a product that completely encircles the outside configuration of the core 7, except for the position wherein the stem 13 attaches to the core 7. The presence of the stem 13 leaves a circular opening or hole 31 (FIG. 9) in the molded product 15. The use of the gas to inflate the product is utilized such that the product 15 is expanded until the hole 31 enlarges to the point that the hole 31 is large enough to allow the product 15 to slip around the core 7, and completely leave the core 7. At this point, the molding process is complete and the product 15 is moved out of the mold 1 and the process is then repeated. This process allows the manufacturer to remove the product 15 in an efficient manner such that the production rate is highly increased over that of cast or vacuum molding, while the product 15 does not suffer any cuts or tears upon the removal from the mold 1.

For purposes of this invention, any polymeric material having properties that will allow it to flow upon injection into the mold, and has the physical properties to withstand the removal process is useful in this invention and when the word “liquid” is used herein, this definition applies thereto. Thus, the polymeric material can be a liquid in the dictionary sense, but can also be a paste, a gum, a gel, or a solid that is flowable under pressure, and the like. Preferred for this invention are silicone polymeric materials that can be cured at room temperature, or at elevated temperatures.

Such materials are well known in the art and are familiar to those that manufacture flexible polymeric products. Such materials are taught, for example, in U.S. Pat. No. 4,172,298, which issued Oct. 30, 1979 to Rechenberg; U.S. Pat. No. 4,247,351, which issued to Rechenberg on Jan. 27, 1981; U.S. Pat. No. 5,738,812, that issued Apr. 14, 1998 to Wild, and U.S. Pat. No. 5,798,062, that issued to Thielbar on Aug. 25, 1998.

It is also contemplated within the scope of this invention to manufacture products having inside and outside surface textures wherein one product can have texturing only on the outside surface, or another product can have texturing on only the inside surface, or both the inside and outside surfaces can have texturing. Methods and processes for texturing the surfaces are also well-known to those skilled in this art and can be found by way of example in U.S. Pat. No. 4,960,425 which issued Oct. 2, 1990 to Yan, et al.; U.S. Pat. No. 5,965,076, which issued Oct. 12, 1999 to Banks, et al., U.S. Pat. No. 5,022,942, that issued Jun. 11, 1991, and U.S. Pat. No. 4,960,425, that issued Oct. 2, 1990 to Yan, et al., although this invention is not limited by the processes set forth and discussed therein.

Attention is now directed to FIGS. 3, 4 and 5, that are three configurations that represent the area designated by the area A of FIG. 2.

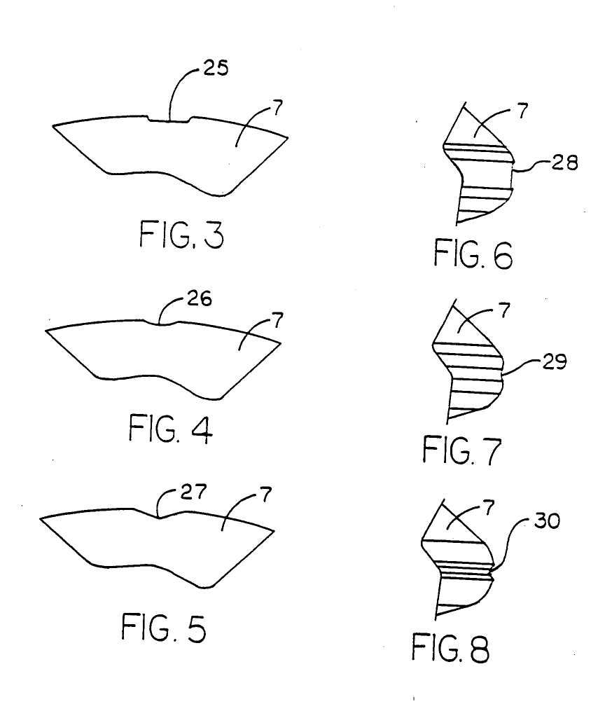

FIG. 3 is a partial segment of the area A wherein the liquid molding material emerges from the gate 19 and impinges on the core 7. This area, because of the need to have the openings for the gate 19, and the opening for the air valve 18, creates a high potential for creating a weak portion in the molded product 15. In order to overcome this weak spot potential, provision is made for extra liquid molding material to build up in this area, and FIGS. 3, 4, and 5 show some of the configurations in the core 7 that can be used at this point to provide the necessary build up of material. For example, FIG. 3 shows a depression 25 with slanted sidewalls to give some depth to the depression 25. FIG. 4 shows a hollow bowl configuration 26, and FIG. 5 shows severely slanted sidewalls 27 which create a wider area, with low depth. Obviously, this creates a need for the valve 17 to be secured slightly below the top surface 8 of the core 7. The configurations described above do not limit this invention, but are shown and discussed to give some examples of how one would provide for the extra protection at this point.

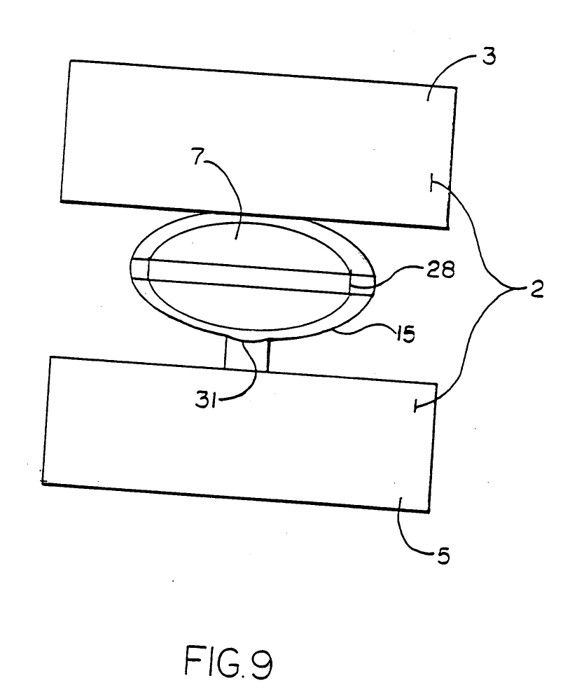

Likewise, another area that is subject to potential weakness in the product 15 is the mold parting line 14 within the mold itself, where the core 7 essentially meets the mold walls 22 and 22′. For example, with reference to FIGS. 6, 7 and 8, there is shown various segments from the area B of FIG. 2, in which FIG. 6 shows a flattened surface 28 running around the outside surface of the core 7, FIG. 7 shows a depression 29 forming a channel around the outside surface of the core 7, and FIG. 8 shows severely slanted walls 30, which creates a ditch around the outside surface of the core 7, all surfaces being configured to provide a small area for build up of the liquid molding material around the outside surface of the core 7 for reinforcement purposes. Those skilled in the art recognize that enough build up is used to reinforce without unnecessarily creating a rise or ridge in this area. Also, it is desirable that one not use too much liquid molding material such that a flash edge is created at these points.

Yet another area that is subject to potential weakness in the product 15 is at the circumference of the hole 31 as the product 15 is being ejected from the core 7. The point of reinforcement is at the edge of opening 23′, and the designs set forth for area B, Supra can be utilized at the edge of the opening 23′ as well to provide support for the leading edge of the hole 31. The configurations shown by FIGS. 3 to 8 can also be used at the opening 23′ to accommodate the build up of the polymeric therein.

The configurations described above do not limit this invention, but are shown and discussed to give some examples of how one would provide for the extra protection at these points.

1. A mold, said mold comprising:
(I) an upper mold segment having an upper surface;
(II) a lower mold segment having a bottom surface, and
(III) a moveable core having a top surface, a bottom surface and a centered opening therethrough, said opening having a near end and a distal end;
wherein each mold segment has a confronting flat surface, each mold segment capable of mating with the other mold segment at their respective confronting flat surfaces;
there being located in the confronting flat surface of each segment, a concavity, each concavity having an opening centered in said concavity;
the opening in the concavity of the lower mold segment running through the lower mold segment and exiting through the bottom surface of the lower mold segment;
the opening in the concavity of the upper mold segment running through the upper mold segment and exiting through the upper surface of the upper mold segment;
the moveable core having an outside configuration essentially identical to the concavities when the mold segments are mated with each other, the core having integrally attached to the bottom thereof, a stem, said stem being slidably mounted in the opening in the concavity of the lower mold segment and extending beyond the bottom surface of the lower mold segment, said stem having centered therethrough, an opening;
the centered opening in the core having an air valve located in and near the near end thereof, said centered opening in the core and said centered opening in the stem being interconnected to allow the intermittent passage of gas therethrough to force any product formed and cured on the core to be inflated and thereby forced from the core, there being a space created between the outside configuration of the core and the concavities when the mold segments are mated.

2. (canceled)

3. A solid molded product produced from the mold of claim 1.

4. The solid molded product of claim 3 wherein the solid molded product is made from curable silicone materials.

5. The solid molded product of claim 4 wherein the outside surface is textured.

6. The solid molded product of claim 4 wherein the inside surface is textured.

7. The solid molded product of claim 4 wherein both the inside and outside surfaces are textured.
